(19) United States
(12) Patent Application Publication
(10) Pub. No.: US 2026/0063804 A1
(43) Pub. Date: Mar. 5, 2026

(54) METHOD AND NON-TRANSITORY COMPUTER-READABLE STORAGE MEDIUM AND APPARATUS FOR ACQUIRING GLOBAL NAVIGATION SATELLITE SYSTEM (GNSS) SIGNALS

(71) Applicant: Airoha Technology Corp., Hsinchu City (TW)

(72) Inventors: Yuan-Wen TING, Hsinchu City (TW); ChingYi HUANG, Hsinchu County (TW); YITING LEE, Tainan City (TW); Ching-Chiao KUAN, Hsinchu County (TW); Chia-Lung WU, Tainan City (TW); Yu-Wei LEE, Hsinchu County (TW)

(73) Assignee: Airoha Technology Corp., Hsinchu City (TW)

(21) Appl. No.: 18/798,231

(22) Filed: Aug. 8, 2024

(51) Int. Cl. G01S 19/28; G01S 19/25

(52) U.S. Cl. CPC G01S 19/28; G01S 19/25

(57) ABSTRACT

The disclosure proposes a method, a non-transitory computer-readable storage medium, and an apparatus for acquiring Global Navigation Satellite System (GNSS) signals. The method is performed by a processor of a baseband integrated circuit (IC) in a GNSS receiver. A search request for starting a search process is received with a maximum current that can be provided to a search engine. The search engine includes a data buffer and a correlation circuitry. The correlation circuitry or the search engine is deactivated when the search process has completed or the search process terminates prematurely.

### BACKGROUND

The disclosure generally relates to global positioning system and, more particularly, to a method, a non-transitory computer-readable storage medium and an apparatus for acquiring Global Navigation Satellite System (GNSS) signals.

Due to the increasing demand of navigation and positioning applications in commercial devices, automobiles, boats, aircrafts, consumer electronics devices or other mobile objects are widely equipped with GNSS receivers. GNSSs are radio-communication infrastructures enabling a generic application to compute position velocity and time at its current location, anywhere on the Earth or in the air, processing the signals transmitted from a constellation of satellites, taken as references points. GNSS signals arrive at ground-based receiver antenna with a low power level. Acquisition of GNSS signals consumes lots of battery power in a GNSS receiver. The reduction of battery power consumption is one of the major signal processing tasks of the GNSS receiver.

### SUMMARY

In an aspect of the present invention, an embodiment discloses a method for acquiring Global Navigation Satellite System (GNSS) signals, performed by a processor of a baseband integrated circuit (IC) in a GNSS receiver. The method includes: receiving a search request for starting a search process with a maximum current that can be provided to a search engine; deactivating the FFT circuitry or the search engine when the search process has completed or the search process terminates prematurely.

The search engine includes a data buffer and a Fast Fourier Transform (FFT) circuitry. The data buffer is arranged operably to collect digital data at baseband signal, down from intermediate frequency (IF), where the digital data corresponds to an GNSS signal received by an antenna of the GNSS receiver. The FFT circuitry is arranged operably to carry out a correlation of the digital data collected in the data buffer with a locally generated Pseudo Random Noise (PRN) code.

In another aspect of the present invention, an embodiment discloses a non-transitory computer-readable storage medium having stored therein program code that, when loaded and executed by a processor, causes the processor to perform the above method for acquiring GNSS signals.

In another aspect of the present invention, an embodiment discloses an apparatus for acquiring GNSS signals. The apparatus, provided in a baseband IC of a GNSS receiver, includes: a search engine including the data buffer and the FFT circuitry; a controller including a first register and a second register; and a processor. The processor is arranged operably to: receive a search request for starting a search process with a maximum current that can be provided to the search engine; deactivate the FFT circuitry or the search engine when the search process has completed or the search process terminates prematurely.

Both the foregoing general description and the following detailed description are examples and explanatory only, and are not restrictive of the invention as claimed.

### BRIEF DESCRIPTION OF THE DRAWINGS

FIG. 1 is a schematic diagram of positioning by an electronic device applying a global navigation satellite system (GNSS) according to an embodiment of the present invention.

FIG. 2 is a block diagram of a GNSS receiver according to some implementations.

FIGS. 3 and 4 are block diagrams showing a GNSS receiver according to embodiments of the present invention.

FIG. 5 is a schematic diagram illustrating a Fast Fourier Transform (FFT) based search implemented in a FFT circuitry according to an embodiment of the present invention.

FIG. 6 is a schematic diagram illustrating a power supply to a data buffer and the FFT circuitry according to an embodiment of the present invention.

FIG. 7 is a flowchart illustrating a method for acquiring GNSS signals according to an embodiment of the present invention.

FIG. 8 is a flowchart illustrating a method for acquiring GNSS signals under the maximum current that can be provided to an L5 search engine according to an embodiment of the present invention.

### DETAILED DESCRIPTION

Reference is made in detail to embodiments of the invention, which are illustrated in the accompanying drawings. The same reference numbers may be used throughout the drawings to refer to the same or like parts, components, or operations.

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that changes may be made in the function and arrangement of elements without departing from the spirit and scope of the application as set forth in the claims.

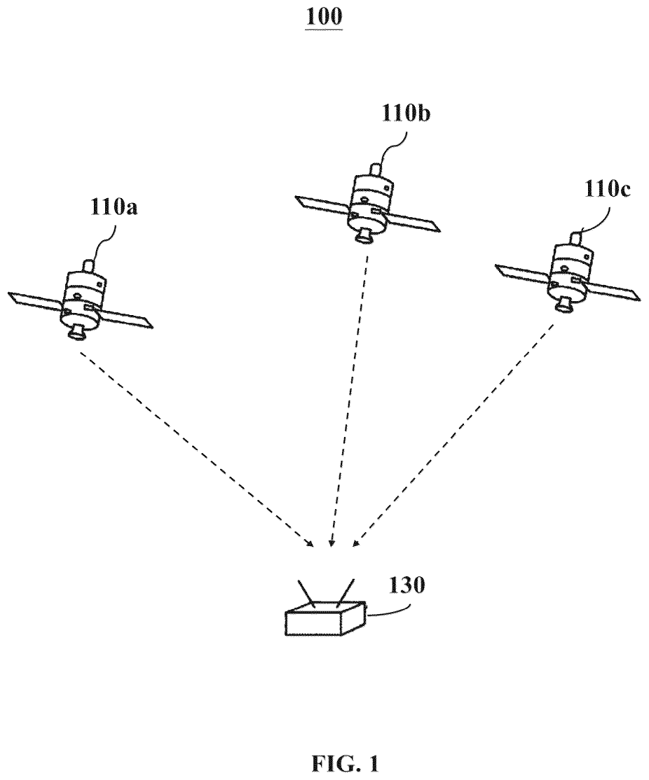

Refer to FIG. 1. An exemplary Global Navigation Satellite System (GNSS) 100 is illustrated, in which the electronic device 130 can determine current positions using wireless techniques. The GNSS 100 is radio communications infrastructure, which enables a generic application to compute position, velocity and time at its current location, anywhere on the Earth or in the air, and processes the signals transmitted from space vehicles (SVs, also referred to as satellite constellations) 110a, 110b, 110c, and so on, taken as references points. The GNSS signal is a radio wave transmitted from the SV 110a, 110b, 110c, or others. Nowadays, at least two global systems are operational: Global Positioning System (GPS), BeiDou, and Galileo. All these systems spread their message modulated with a higher rated Pseudo-Random Noise (PRN) code, which is then modulated with a Binary Phase Shift Keying (BPSK), or other modulation and transmitted over Radio Frequency (RF). Although the GNSS system is constructed by many SVs, the PRN code is unique to each SV. Identifying the PRN code carried in the received GNSS signal is synonymous with identifying the SV corresponding to the received GNSS signal. In some embodiments, the PRN code is referred to as the PRN sequence. The International Telecommunications Union (ITU) coordinates the shared global use of the radio spectrum. The exemplary GNSS constellations, bands and frequencies are listed in Table 1:

TABLE 1

| Constel- | | Frequency in MHz | | | |
|---|---|---|---|---|---|
| lations | Bands | Centre | Bandwidth | Lower | Upper |
| GPS | L1 | 1575.42 | ±2 | 1573.42 | 1577.42 |
| | (i.e., L1 | | ±1.023 | 1574.397 | 1576.443 |
| | with C/A | | ±10.23 | 1565.19 | 1585.65 |
| | code) | | ±15 | 1560 | 1590 |
| | L5 | 1176.45 | ±10.23 | 1166.22 | 1186.68 |
| Galileo | E1 | 1575.42 | ±12.276 | 1563.144 | 1587.696 |
| | E5a | 1176.45 | ±10.23 | 1166.22 | 1186.68 |
| | E5b | 1207.14 | ±10.23 | 1196.91 | 1217.37 |
| BeiDou | B1I | 1561.098 | ±2.046 | 1559.052 | 1563.14 |
| | B2a | 1176.45 | ±10.23 | 1166.22 | 1186.68 |
| | B2b | 1207.14 | ±10.23 | 1196.91 | 1217.37 |

At present, each of the GPS, the BeiDou, and the Galileo systems has 30 SVs or more in operation. Several signals are available per SV in a specific global system. For example, L1 and L5 signals come from the same SV in the GPS system. The L5 band is the lower band and includes a data channel and a pilot channel. E1 and E5 signals come from the same SV in the Galileo system. The E5 band includes the lower band (E5a band) and the upper band (E5b band). Each of the E5a and E5b bands has a data channel and a pilot channel. B1 and B2 signals come from the same SV in the BeiDou system. The B2 band includes the lower band (B2a band) having a data channel and a pilot channel, and the upper band (B2b band) having a data channel only. The data channel is used to carry a navigation message and the pilot channel is used for determining the pseudoranges between the SV and the GNSS receiver.

The L5, E5 and B2 signals are collectively referred to as L5-series signals, which are broadcasted at a frequency in the 52 MHz band centered at 1191.795 MHz (so-called L5 band). The L5-series signals have a higher chipping rate (usually 10 times) than the L1, E1 and B1 signals. The higher chipping rate introduces a higher sampling frequency, which implies itself a significant amount of samples to store and process, and a lower ratio between the clock frequency of the acquisition process and the sampling frequency, which leads to a longer processing time. The L5-series signals have a higher power than the L1, E1 and B1 signals. For example, the pilot channel of the L5 signal is higher than the L1 signal by 1.5 dB, the E5a and E5b signals are higher than the E1 signal for the pilot channel by 2 dB, and so on.

Taking GPS as an example, each of the SVs 110a, 110b and 110c transmits a GNSS signal as a positioning signal. L1 signals include satellite orbit information and navigation messages. The navigation message includes time information based on the satellite's high precision clock, and is phase-modulated with a PRN code composed of 1023 chips at a chip rate of 1.023 MHz. In L1 C/A (L1 Coarse/Acquisition), each frame is divided into five subframes and is constituted as a bit string of 300 bits, which includes the satellite orbit information and the navigation messages. In each subframe, the PRN code with a period of 1 ms is repeated, and the phase of the PRN code is inverted if there is a bit switch. Each SV 110a, 110b or 110c repeatedly transmits a frame, which is a basic unit of navigation messages. L5 signals include satellite orbit information and navigation messages phase-modulated with a PRN code composed of 10230 chips at a chip rate of 10.23 MHz. In L5-CNAV (L5 Civil NAVigation), each message is composed by fixed data such as a Preamble, PRN, Message Type ID, Alert Flag, message TOW (Time of Week) count, and CRC (Cyclical Redundant Check), and 238 bits to be filled with other navigation related data. Each SV 110a, 110b or 110c repeatedly transmits messages.

The electronic device 130 may be installed in an automobile, a boat, an aircraft, a consumer electronics device or others. The electronic device 130 has a stand-alone GNSS receiver to acquire ephemeris data, an almanac, a reference time, and other measurements used to compute a location, thus to have satellite wireless positioning capabilities. In some embodiments, the electronic device 130 incorporates with the geographic information system (GIS) to display moving maps and information about location, speed, direction, nearby streets, etc.

Since the GNSS is a spread spectrum communications system, the GNSS receiver performs de-spreading to correlate (time-domain or frequency-domain correlate) baseband input data corresponding to a received GNSS signal with a local replica and accumulate the correlation results. The length and the chip rate of the PRN code (also referred to as the ranging code) in the L5-series signals is 10 times longer than that in the L1 signals, 2.5 times longer than that in the E1 signals, and 5 times longer than that in the B1 signals. The L5-series signals provide more accurate information and are primarily employed in the positioning by the GNSS receiver. However, the GNSS receiver consumes greater computation time and power to determine which SVs broadcasting the L5-series signals (also referred to as visible SVs) and de-spread the acquired L5-series signals than the determination and the de-spreading for the L1, E1 and B1 signals.

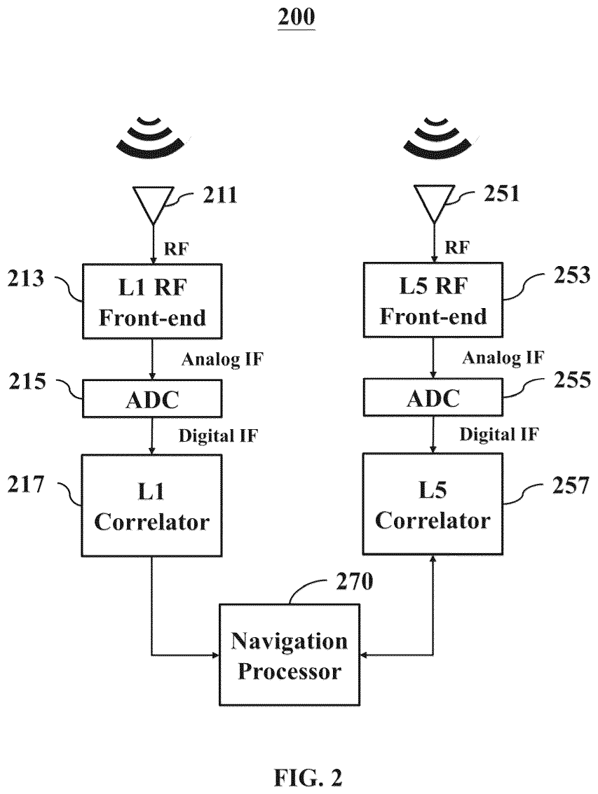

In some implementations, the GNSS receiver is designed to be a dual-band GNSS receiver, which receives two different GNSS signals at frequencies in different bands from the SVs 110a, 110b, 110c, and others. Refer to FIG. 2 showing a block diagram of the dual-band GNSS receiver. The dual-band GNSS receiver 200 is equipped with two sets of hardware for the GNSS signals in two bands, respectively. The antenna 211, the L1 radio frequency (RF) front-end 213, the analog-to-digital converter (ADC) 215 and the L1 correlator 217 are utilized to acquire L1, E1 and B1 signals broadcasted from 1559 MHz to 1610 MHz (so-called L1 band) from visible SVs, discriminate and, de-spread the digital data corresponding to the acquired L1, E1 and B1 signals. The code index of the matched PRN code and the de-spread data is decoded and analyzed by the navigation processor 270. The operations described above may be referred to as a coarse search. The navigation processor 270 decodes the satellite orbit information and the navigation message from the data generated by the L1 correlator 217. The navigation processor 270 sends the code index of the matched PRN code, and relevant parameters carried in the satellite orbit information and the navigation message (also referred to as aiding information) to the L5 correlator 257. The antenna 251, the L5 RF front-end 253, the ADC 255 and the L5 correlator 257 facilitates the acquisition of the L5-series signals broadcasted at frequencies in the L5 band from visible SVs, the discrimination and the de-spreading of the digital data corresponding to the acquired L5-series signals according to the aiding information. But, extra hardware cost is spent for the antenna 211, the L1 RF front-end 213, the ADC 215 and the L1 correlator 217.

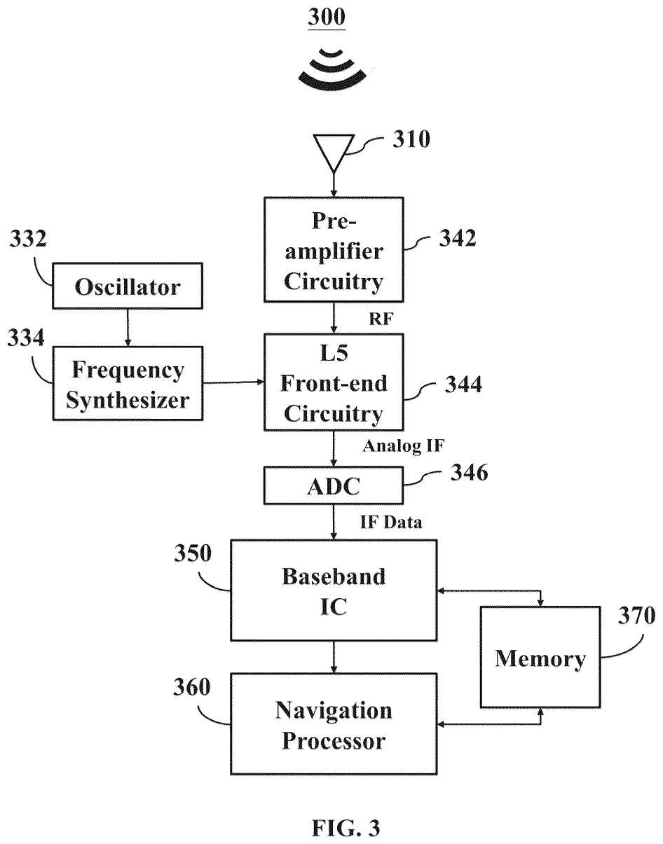

To reduce the hardware cost, an embodiment of the present invention discloses a design to remove hardware components for acquiring L1, E1 and B1 signals in the L1 band from visible SVs, discriminating and de-spreading the digital data corresponding to the acquired L1, E1 and B1 signals from the GNSS receiver. Refer to FIG. 3 showing the block diagram of the GNSS receiver 300 according to an embodiment of the present invention. The GNSS receiver 300 includes the L5-band antenna 310, the oscillator 332, the frequency synthesizer 334, the pre-amplifier circuitry 342, the L5 front-end circuitry 344, the ADC 346, the baseband Integrated Circuit (IC) 350, the navigation processor 360 and the memory 370.

The oscillator 332 generates a signal of a predetermined frequency by oscillating an oscillator made of, for example, crystal, and outputs the generated signal to the frequency synthesizer 334. The frequency synthesizer 334 generates a clock signal of a predetermined frequency (clock frequency) based on the signal output from the oscillator 332, and outputs the generated clock signal to the L5 front-end circuitry 344.

Following the L5-band antenna 310, the pre-amplifier circuitry 342 sets the noise figure for the entire receiver system and may include a Low-Noise Amplifier (LNA) to amplify a low-power GNSS signal received by the antenna 310, and outputs the amplified GNSS signal to the L5 front-end circuitry 344.

The L5 front-end circuitry 344 involves filtering, amplification and downconverter. Given the low power of the received GNSS signal, out-of-band interference is suppressed using cutoff filters, which may be accomplished by Surface Acoustic Wave (SAW) device. The amplification in multibit receivers may employ some form of automatic gain control (AGC). The downconverter converts the frequency of the GNSS signal in the L5 band to an intermediate frequencies (IF) that is a frequency division ratio multiple of the clock frequency, and outputs the GNSS signal at the IF to the ADC 346. The downconverter is performed in single or multiple stages. Multistage architectures allow for adequate image suppression and general bandpass filtering with the final IFs close to the Baseband IC 350. The image suppression in the single-stage downconverter may be achieved by accepting a higher IF. The downconverter includes a carrier Voltage Controlled Oscillator (VCO) and a mixer. The mixer mixes the GNSS signal acquired from the pre-amplifier circuitry 342 and the output from the carrier VCO controlled to match a phase of the clock frequency with the mixer. The final conversion to baseband involves converting the IF signal to the in-phase (I) and quadrature (Q) components of the signal envelop. It is accomplished by mixing the IF signal with two tones generated at the final nominal IF but with one tone lagging the other in phase by π/2 radians. The output of the mixer may be the baseband components plus Doppler frequency.

The ADC 346 converts the GNSS signal at the IF into digital data, and outputs the digital data corresponding to the GNSS signal at the IF to the Baseband IC 350. The single-bit or the multibit architecture may be used in the ADC 346.

The Baseband IC 350 includes dedicated hardware (such as carrier Numerically Controlled Oscillator (NCO), registers, static random access memory (SRAM), mixers, complex multipliers, accumulators, etc.) and a Digital Signal Processors (DSP), a microcontroller unit (MCU), a an application specific integrated circuits (ASIC), a general-purpose processor, a field programmable logic array (FPGA), or the like, being configured when executing specific program code to perform a wide range of mathematic and logical calculations with relevant data flow controls. The navigation processor 360 may be implemented in numerous ways, such as with general-purpose hardware (e.g., a MCU, a single processor, a multi-core processor, a Graphics Processing Unit (GPU), or others) that is programmed using firmware and/or software instructions to perform the specific functions.

For each SV visible in view, the GNSS receiver 300 tries to extract the corresponding satellite orbit information and navigation messages from L5-series signals (referred to as an L5 search process). The L5 search process includes two essential and sequential processes: the acquisition process and the tracking process. The acquisition process is the process by which the GNSS receiver 300 identifies which SV are visible. It is a three-dimensional search to determine the SV identifier (i.e. the Coarse/Acquisition-CIA code, or PRN code associated with a specific SV), code phase, and carrier frequency offset due to Doppler effect. Once the acquisition process is accomplished, L5-series signals need to be tracked over time. In the tracking process, the satellite orbit information and the navigation messages of the corresponding SV are extracted.

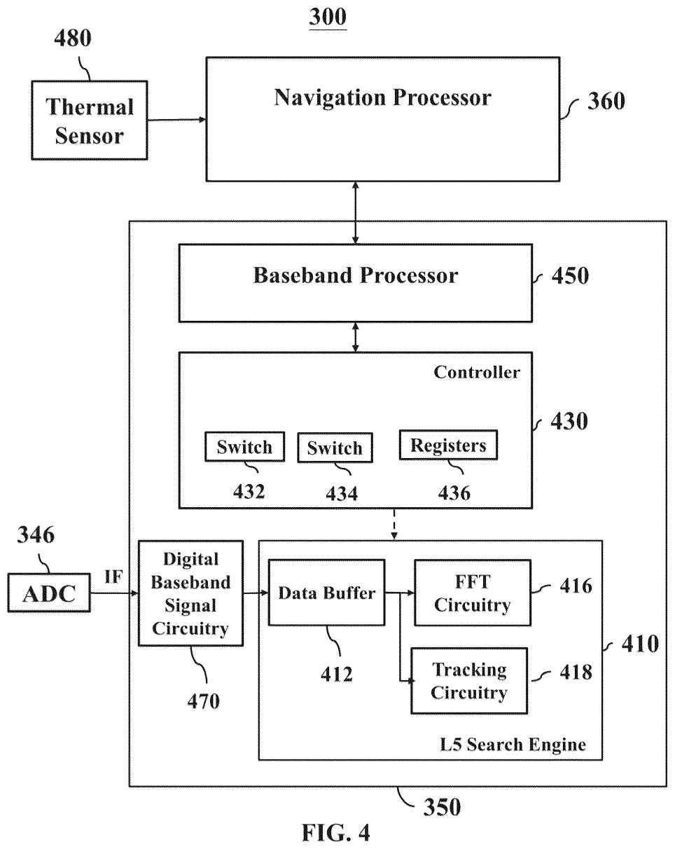

The Baseband IC 350 performs a process for acquiring GNSS signals in the L5 band, which includes simultaneous searches of frequency and code offset. The process is repeatedly performed to acquire GNSS signals in designated channels of the L5 band broadcasted by designated SVs according to a channel-search schedule. Refer to FIG. 4 showing a block diagram of a GNSS receiver. The Baseband IC 350 includes the L5 search engine 410, the controller 430 and the baseband processor 450. The navigation processor 360 identifies the SVs that are visible to the GNSS receiver. The L5 search engine 410 is used to receive information about the visible SVs from the navigation processor 360, and provide the measurement of Doppler shift in carrier frequency and delay in the PRN code of the incoming GNSS signal. Doppler shift in carrier frequency of GNSS signal is due to the relative velocity between an SV and the GNSS receiver. The PRN code delay is due to the transit time of GNSS signal from an SV to the GNSS receiver. The tracking circuitry 418 of the Baseband IC 350 tracks each visible SV and extract the satellite orbit information and the navigation messages from the incoming GNSS signal broadcasted by the visible SV.

The Baseband IC 350 includes the digital baseband signal circuitry 470, and the digital baseband signal circuitry 470 receives the digital data at IF output from the ADC 346 and down-converts the IF data into digital baseband data. The L5 search engine 410 includes the data buffer 412, and the data buffer 412 is arranged operably to collect digital baseband data output from the digital baseband signal circuitry 470, where the digital baseband data corresponds to an L5-series signal received by the antenna 310. The data buffer 412 can be implemented by registers, or can be space allocated in a SRAM. The L5 search engine 410 further includes the Fast Fourier Transform (FFT) circuitry 416, and the FFT circuitry 416 is arranged operably to carry out correlations of the digital baseband data collected in the data buffer 412 with a locally generated PRN code in an acquisition process. The FFT circuitry 416 uses circular correction search scheme based on FFT and Inverted FFT (IFFT) for acquisition.

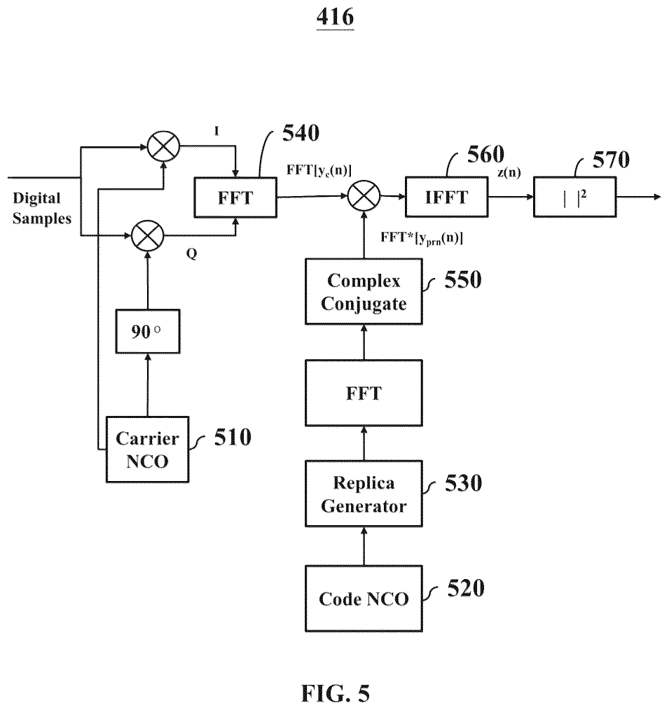

Refer to FIG. 5 showing a schematic diagram of exemplary FFT based search implemented in the FFT circuitry 416. The digital samples output from the data buffer 412 are mixed with in-phase and quadrature outputs of the carrier numerically controlled oscillator (NCO) 510 to produce I and Q data streams. The replica generator 530 generates a copy of a PRN code according to an output of the code NCO 520. The output of the FFT block 540 denotes FFT[y_{c}[n]], where FFT[ ] is Fast Fourier Transform and y_{c}[n] is locally generated data at an instant ‘n’. The output of complex conjugate block 550 denotes FFT*[yₚᵣₙ[n]], where FFT*[ ] is complex conjugate of the output of FFT and yₚᵣₙ[n] is locally generated PRN code at the instant ‘n’ by the replica generator 530. The output of the IFFT block 560 denotes z(n)=IFFT(FFT[y_{c}[n]] FFT*[yₚᵣₙ[n]]), where z(n) is a correlation between the locally generated data and the locally generated PRN code at the instant ‘n’ and IFFT( ) is Inverted FFT. The output of the absolute power block 570 is the highest absolute value of correlation power of z(n) to indicate a complex with the maximum peak at the instant ‘n’. The FFT search is exhaustive and consumes excessive battery power. It is noted that the FFT circuitry 416 is an embodiment for illustration, those skilled in the art may realize the FFT based search by similar but different circuitry or circuitries depending on different system requirements, and the invention should not be limited thereto.

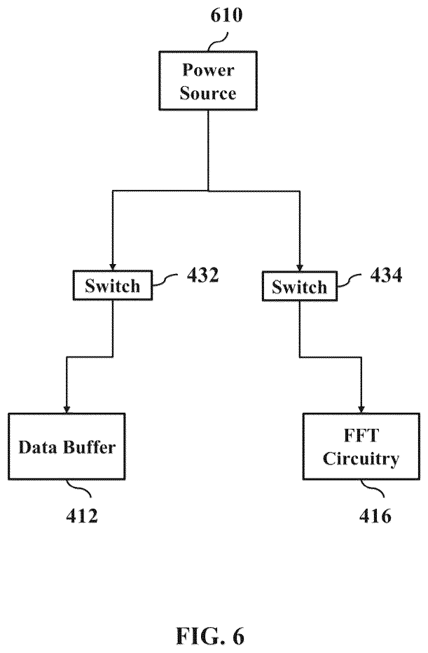

Referring back to FIG. 4, the controller 430 is equipped with two switches 432 and 434. The overall L5 search engine 410 and the FFT circuitry 416 can be controlled to be deactivated to reduce battery power consumption. Refer to FIG. 6 showing a schematic diagram of power supply to the data buffer 412 and the FFT circuitry 416. Power is provided from the power source 610 to the data buffer 412 through the switch 432 when the switch 432 is turned on (i.e., conducted). Power is provided from the power source 610 to the FFT circuitry 416 through the switches 434 when the switches 434 are turned on (i.e., conducted). In some embodiments, the controller 430 turns off the switches 432 and 434 to stop the power supply to the overall L5 search engine 410 including the data buffer 412 and the FFT circuitry 416 according to a control signal issued by the baseband processor 450, so that the data buffer 412 and the FFT circuitry 416 are deactivated. In alternative embodiments, since the digital samples in a continuous time period should be long enough to perform coherent and non-coherent combining by the FFT circuitry 416, the controller 430 turns off the switch 434 to stop the power supply to the FFT circuitry 416 only in response to a request by the baseband processor 450, and keeps the data buffer 412 to collect digital data from the ADC 346. The FFT circuitry 416 after being activated again would resume the correlation of the digital samples received from the data buffer 412 with a copy of the PRN code generated by the replica generator 530 as soon as possible, and output a complex with the maximum peak per time unit (such as 1 or 2 ms).

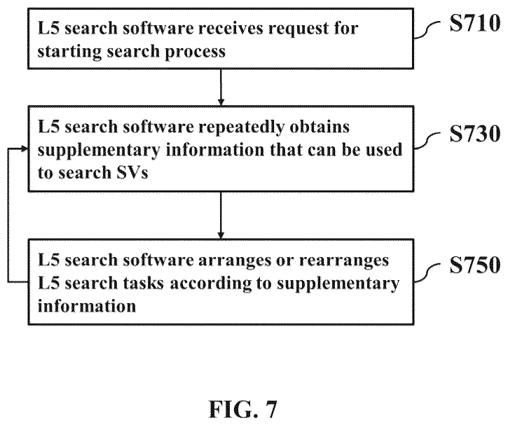

Without the aid of L1, B1 or E1 signals, the FFT circuitry 416 needs to be carefully activated and controlled to avoid excessive battery power consumption. Refer to FIG. 7 illustrating another method for acquiring GNSS signals, performed by an L5 search software running on the baseband processor 450. The method repeatedly executes a loop for dynamically arranging or rearranging L5 search tasks according to up-to-date supplementary information after receiving a request for starting a search process. The details are as follows:
Step S710: The L5 search software receives a request for starting a search process from a system software running on the navigation processor 360.
Step S730: The L5 search software repeatedly obtains supplementary information that can be used to search SVs. The supplementary information includes but not limits to the temperature sensed by the thermal sensor 480, the antenna configuration in the GNSS receiver 300, relevant data and parameters of the visible SVs, and the search and tracking statuses of each SV.
Step S750: The L5 search software arranges or rearranges L5 search tasks for driving the L5 search engine 410 according to the supplementary information.

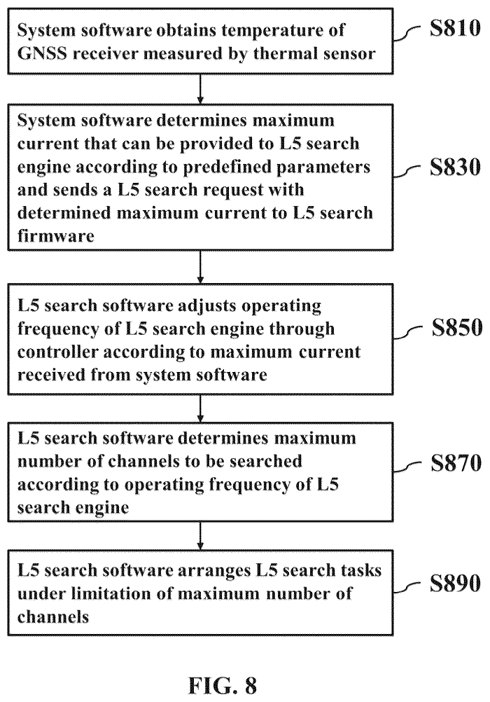

Refer to FIG. 8 illustrating a method for acquiring GNSS signals, performed by a system software running on the navigation processor 360 in coordination with an L5 search software running on the baseband processor 450, under the maximum current that can be provided to the L5 search engine 410. The details are as follows:
Step S810: The system software actively or passively obtains a temperature of the GNSS receiver 300 measured by the thermal sensor 480.
Step S830: The system software determines a maximum current that can be provided to the L5 search engine 410 according to predefined parameters, such as the activated module in the GNSS receiver 300, the obtained temperature of the GNSS receiver 300, and others. When the GNSS receiver 300 needs to be positioned, the system software sends an L5 search request for starting an L5 search process with the determined maximum current to the L5 search software.
Step S850: After receiving the L5 search request, the L5 search software adjusts the operating frequency of the L5 search engine 410 by the controller 430 according to the maximum current received from the system software. The L5 search software sets the designated register 436 of the controller 430 to inform the controller 430 of the operating frequency of the L5 search engine 410. The controller 430 accordingly adjust the frequency of the clock signal fed into the L5 search engine 410, thereby enabling the L5 search engine to operate at the desired operating frequency. For example, if the maximum current is 130 mA, then the L5 search software sets the operating frequency of the L5 search engine 410 to 200 MHz. If the maximum current is 60 mA, then the L5 search software sets the operating frequency of the L5 search engine 410 to 90 MHz. To sum up, if the maximum current that can be provided to the L5 search engine 410 is higher, the L5 search engine 410 can operate at a higher clock frequency, and vice versa.
Step S870: The L5 search software determines a maximum number of channels to be searched in this L5 search process according to the operating frequency of the L5 search engine 410. It also implies that the maximum number of channels to be searched is determined based on the maximum current received from the system software. The controller 430 arranges search tasks under the limitation of the maximum number of channels to be searched. For example, if the operating frequency of the L5 search engine 410 is adjusted to 200 MHz, the L5 search software arranges no more than 40 tasks to acquire L5-series signal. The 40 tasks may include searches for 10 SVs by 4 channels, 20 SVs by 2 channels, 40 SVs by 1 channel, or others. If the operating frequency of the L5 search engine 410 is adjusted to 90 MHz, the L5 search software arranges no more than 16 tasks to acquire L5-series signal. The 16 tasks may include searches for 4 SVs by 4 channels, 8 SVs by 2 channels, 16 SVs by 1 channel, or others. To sum up, if the operating frequency of the L5 search engine 410 is higher, the maximum number of search tasks is greater, and vice versa.

A mapping table may be provided in the baseband IC 350 to facilitate the determinations in steps S850 and S870 by the L5 search software. The mapping table may be stored in a SRAM (not shown in FIG. 4) in the baseband IC 350. The exemplary mapping table is shown in Table 1:

TABLE 1

| | | Maximum number |
|---|---|---|
| Maximum supported | Operating Frequency | of channels to |
| current (mA) | of L5 search engine | be searched |
| >=130 | 200 MHz | 40 |
| >=60 AND <130 | >90 AND <200 MHz | >16 AND <40 |
| 60 | 90 MHz | 16 |

Step S890: The L5 search software arranges search tasks under the limitation of the maximum number of channels to be searched. Each search task includes a search for the data channel of the lower band, the pilot channel of the lower band, the data channel of the upper band, or the pilot channel of the upper band. The detailed information for each of the arranged search tasks, such as identifications (IDs) of a specific SV, a specific band and a specific channel, a non-coherent time period (in ms), and others, is stored in the registers 436 of the controller 430. Based on the settings of the registers 436 for each search task, the baseband processor 450 configures the carrier VCO in the L5 front-end circuitry 344 to enable the L5 front-end circuitry 344 to acquire an L5-series signal at a frequency of a specific band (for example, the lower band, or the upper band), configures the replica generator 530 to generate a specific PRN code corresponding to a specific SV broadcasting the L5-series signal at the specific frequency of the specific channel of the specific band, and configures the FFT circuitry 416 to perform the correlations for a specific non-coherent time period. The maximum peak per time unit with identification information about a specific SV, which is output from the FFT circuitry 416, may be stored in an SRAM (not shown in FIG. 4) of the baseband IC 350, so that the system software running on the navigation processor 360 or the baseband processor 450 of the Baseband IC 350 can examine the acquisition outcomes accordingly.

Several scenarios are illustrated to describe exemplary arrangements or rearrangements of search tasks performed in step S750 or S890:

In response to an L5-series signal broadcasted by a specific SV being predicted to be weak according to aiding information, four tasks are arranged for this SV to acquire L5-series signals from the data channel of the lower band, the pilot channel of the lower band, the data channel of the upper band, and the pilot channel of the upper band, respectively. The aiding information may be obtained from historical records stored in an assistant server in the Internet or the telecommunications network. In the historical records, the signal strength of L5-series signals broadcasted by this SV may be measured by carrier-to-noise density (C/N₀), signal-to-noise ratio (SNR), or others. A threshold may be set to distinguish whether the acquired L5-series signals are strong or weak. In alternative embodiments, three tasks are arranged for this SV to acquire L5-series signals from the data channel of the lower band, the pilot channel of the lower band, and the data channel of the upper band, respectively in such scenario. In alternative embodiments, two tasks are arranged for this SV to acquire L5-series signals from the data channel of the lower band, and the pilot channel of the lower band, respectively in such scenario.

In response to no antenna being equipped in the GNSS receiver 300 for receiving an L5-series signal at a frequency in the upper band, at most two tasks are arranged for each SV to acquire L5-series signals from the data channel of the lower band, and the pilot channel of the lower band, respectively.

Alternatively, in response to no antenna being equipped in the GNSS receiver 300 for receiving an L5-series signal at a frequency in the lower band, at most two tasks are arranged for each SV to acquire L5-series signals from the data channel of the upper band, and the pilot channel of the upper band, respectively.

In response to an L5-series signal broadcasted by a specific SV being predicted to be strong according to aiding information, one task is arranged for this SV to acquire L5-series signals from the pilot channel of the lower band.

The arranged search tasks may be dynamically modified during the L5 search process with condition changes: In a use case, the system software discovers that one or more SVs are invisible currently by already decoded navigation messages broadcasted from other SV or SVs, and informs the L5 search software of information indicating that specific SVs are invisible currently. The L5 search software modifies the settings of the registers 436 of the controller 430 to remove all search tasks related to the invisible SVs and rearrange the execution order for the remaining search tasks.

In another user case, at the beginning of the L5 search process, the maximum number of channels is limited to 40 in response to the maximum current that can be provided to the L5 search engine 410 is 130 mA, and the operating frequency of L5 search engine is 200 MHz. During the L5 search process, the system software detects that the maximum current that can be provided to the L5 search engine 410 drops. The system software promptly informs the L5 search software that the supported maximum operating frequency has dropped to 100 MHz. The L5 search software modifies the settings of the registers 436 of the controller 430 to remove certain search tasks, so as to limit the number of remaining search tasks to 20.

In another use case, the non-coherent time period for each search task is initially set to a predefined time period (e.g. 1000 ms). During the L5 search process, the system software detects that the tracking circuitry 418 of the baseband IC 350 spends only a short time period (e.g. 10 ms) to complete the tracking process for one SV (for example, SV9). Specifically, the system software continuously obtains tracking results from the tracking circuitry 418 with a shorter coherent or non-coherent time for SV9. The satellite orbit information and the navigation message can be decoded from the tracking results output from the tracking circuitry 418. The system software may discover that at least one SV (for example, SV1) is located at an azimuth and elevation angle close to that of the SV9 from already decoded ephemeris data broadcasted by another SV. Any SV being located at an azimuth and elevation angle close to that of the SV9 means that the difference between azimuth and elevation angles that this SV and SV9 locates is smaller than a predefined threshold. Moreover, the azimuth and elevation angle of SV1 is in line of sight (LOS) with strong signal. The system software informs the L5 search software that specific SV or SVs are currently located near SV9 and the tracking process for SV9 only consumes 10 ms. The L5 search software modifies the settings of the registers 436 of the controller 430 to set the non-coherent time period(s) of the search task(s) for the specific SV(s) to 10 ms.

When the L5 search process has completed or the system software determines to terminate the L5 search process prematurely, the L5 search software may turn off the switches 432 and 434 of the controller 430 to deactivate the overall L5 search engine 410, or turn off the switch 434 to deactivate the FFT circuitry 416 only, so that the battery power consumption is reduced.

Although the embodiments describe the search task arrangements in the L5 search engine 410, those skilled in the art may apply the method, the non-transitory storage medium and the apparatus for acquiring GNSS signals from another GNSS band for saving battery power.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims.

One having ordinary skill in the art will readily understand that the invention as discussed above may be practiced with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent.” etc.)

The term “device” or “module” is not limited to one or a specific number of physical objects (such as one electronic device, one controller, one processing system and so on). As used herein, a device may be any electronic device with one or more parts that may implement at least some portions of the invention in this disclosure. While the description and examples use the term “device” or “module” to describe various aspects of this disclosure, the term “device” or “module” is not limited to a specific configuration, type, or number of objects. Additionally, the term “system” or “module” is not limited to multiple components or specific aspects. For example, a system may be implemented on one or more printed circuit boards or other substrates and may have movable or static components. While the description and examples use the term “system” to describe various aspects of the invention in this disclosure, the term “system” is not limited to a specific configuration, type, or number of objects.

Specific details are provided in the description above to provide a thorough understanding of the aspects and examples provided herein. However, it will be understood by one of ordinary skills in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Some or all of the aforementioned embodiments of the method of the invention may be implemented in a computer program such as DSP code, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

The program code may be executed by a processor, which may include one or more processors, such as one or more microcontroller units (MCUs), digital signal processors (DSPs), general-purpose processors, application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Although the embodiment has been described as having specific elements in FIGS. 3-6, it should be noted that additional elements may be included to achieve better performance without departing from the spirit of the invention. Each element of FIGS. 3-6 is composed of various circuitries and arranged to operably perform the aforementioned operations. While the process flows described in FIG. 7 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for acquiring Global Navigation Satellite System (GNSS) signals, performed by a processor of a baseband integrated circuit (IC) in a GNSS receiver, comprising:
receiving a search request for starting a search process with a search engine, wherein the search engine comprises a data buffer and a correlation circuitry, the data buffer is arranged operably to collect digital baseband data, the digital baseband data corresponds to an GNSS signal received by an antenna of the GNSS receiver, and the correlation circuitry is arranged operably to carry out a correlation of the digital baseband data collected in the data buffer with a locally generated Pseudo Random Noise (PRN) code;
repeatedly obtaining supplementary information that can be used to search a space vehicle (SV); and
arranging or rearranging a plurality of search tasks for driving the search engine according to the supplementary information.

2. The method of claim 1, comprising:
receiving a maximum current that can be provided to the search engine;
adjusting an operating frequency of the search engine according to the maximum current that can be provided to the search engine;
determining a maximum number of channels to be searched according to the maximum current that can be provided to the search engine; and
arranging the search tasks under a limitation of the maximum number of channels to be searched when the search engine is activated, wherein each search task comprises a search for a data channel of a lower band, a pilot channel of the lower band, a data channel of an upper band, or a pilot channel of the upper band, whereby enabling a controller of the baseband IC to control the search engine to perform an acquisition process for acquiring an GNSS signal from a specific channel of a specific band with a specific SV for a specific non-coherent time period based on each search task.

3. The method of claim 1, comprising:
arranging more than one search tasks for a first SV in response to a first L5-series signal, broadcasted by the first SV, being predicted to be weak.

4. The method of claim 1, comprising:
arranging at most two tasks for each SV for enabling the search engine to acquire an L5-series signal from the pilot channel and the data channel of the lower band in response to no antenna being provided in the GNSS receiver for receiving an L5-series signal at a frequency in the upper band.

5. The method of claim 1, comprising:
arranging one search task for a second SV to acquire a second L5-series signal from the pilot channel of the lower band in response to the second L5-series signal broadcasted by the second SV and being predicted to be strong.

6. The method of claim 1, comprising:
receiving information indicating that a third SV is invisible currently during the search process; and
removing all search task or tasks related to the third SV and rearranging an execution order for remaining search tasks during the search process.

7. The method of claim 1, comprising:
receiving information indicating that the maximum current that can be provided to the search engine drops to a predefined level during the search process; and
removing one or more search tasks in response to a dropping of the maximum current that can be provided to the search engine during the search process.

8. The method of claim 1, comprising:
receiving information indicating that a fourth SV is currently located at an azimuth and elevation angle close to that of a fifth SV and the azimuth and elevation angle is at a light of sight with a strong signal, and a tracking process for the fifth SV has completed for a time period shorter than a non-coherent time period in a search task for the fourth SV during the search process; and
modifying the non-coherent time period in the search task for the fourth SV with the time period in response to received information during the search process.

9. The method of claim 1, comprising:
deactivating the correlation circuitry or the search engine when the search process has completed or the search process terminates prematurely.

10. A non-transitory computer-readable storage medium having stored therein program code, that, which loaded and executed by a processor of a baseband integrated circuit (IC) in a Global Navigation Satellite System (GNSS) receiver, cause the processor to perform a method for acquiring GNSS signals to:
receive a search request for starting a search process with a search engine, wherein the search engine comprises a data buffer and a correlation circuitry, the data buffer is arranged operably to collect digital baseband data, the digital baseband data corresponds to an GNSS signal received by an antenna of the GNSS receiver, and the correlation circuitry is arranged operably to carry out a correlation of the digital baseband data collected in the data buffer with a locally generated Pseudo Random Noise (PRN) code;
repeatedly obtaining supplementary information that can be used to search a space vehicle (SV); and
arranging or rearranging a plurality of search tasks for driving the search engine according to the supplementary information.

11. The non-transitory computer-readable storage medium of claim 10, wherein the program code that, when loaded and executed by the processor, causes the processor to:
receive a maximum current that can be provided to the search engine;
adjust an operating frequency of the search engine according to the maximum current that can be provided to the search engine;
determine a maximum number of channels to be searched according to the maximum current that can be provided to the search engine; and
arrange the search tasks under a limitation of the maximum number of channels to be searched, wherein each search task comprises a search for a data channel of a lower band, a pilot channel of the lower band, a data channel of an upper band, or a pilot channel of the upper band, whereby enabling a controller of the baseband IC to control the search engine to perform an acquisition process for acquiring an GNSS signal from a specific channel of a specific band with a specific SV for a specific non-coherent time period based on each search task.

12. The non-transitory computer-readable storage medium of claim 10, wherein the program code that, when loaded and executed by the processor, causes the processor to:
receive information indicating that a fourth SV is currently located at an azimuth and elevation angle close to that of a fifth SV and the azimuth and elevation angle is in line of sight with a strong signal, and a tracking process for the fifth SV has completed for a time period shorter than a non-coherent time period in a search task for the fourth SV during the search process; and
modify the non-coherent time period in the search task for the fourth SV with the time period in response to received information during the search process.

13. An apparatus for acquiring Global Navigation Satellite System (GNSS) signals, provided in a baseband integrated circuit (IC) of a GNSS receiver, comprising:
a search engine, comprising:
a data buffer, arranged operably to collect digital baseband data, wherein the digital baseband data corresponds to an GNSS signal received by an antenna of the GNSS receiver; and
a correlation circuitry, coupled to the data buffer, arranged operably to carry out a correlation of the digital baseband data collected in the data buffer with a locally generated Pseudo Random Noise (PRN) code; and
a processor, coupled to the controller, arranged operably to: receive a search request for starting a search process with the search engine; repeatedly obtain supplementary information that can be used to search a space vehicle (SV); and arrange or rearrange a plurality of search tasks for driving the search engine according to the supplementary information.

14. The apparatus of claim 13, wherein the controller comprises a first register and a second register, and the processor is arranged operably to: adjust an operating frequency of the search engine according to the maximum current that can be provided to the search engine by setting the first register of the controller, whereby enabling the controller to control the search engine to operate at the operating frequency; determine a maximum number of channels to be searched according to the maximum current that can be provided to the search engine; and arrange the search tasks under a limitation of the maximum number of channels to be searched by setting the second register of the controller, each search task comprises a search for a data channel of a lower band, a pilot channel of the lower band, a data channel of an upper band, or a pilot channel of the upper band, whereby enabling the controller to control the search engine to perform an acquisition process for acquiring an GNSS signal from a specific channel of a specific band with a specific SV for a specific non-coherent time period based on each search task.

15. The apparatus of claim 13, wherein the processor is arranged operably to: arrange at most two tasks for each SV for enabling the search engine to acquire an L5-series signal from the pilot channel and the data channel of the lower band in response to no antenna being provided in the GNSS receiver for receiving an L5-series signal at a frequency in the upper band.

16. The apparatus of claim 13, wherein the processor is arranged operably to: arrange one search task for a second SV to acquire a second L5-series signal from the pilot channel of the lower band in response to the second L5-series signal broadcasted by the second SV and being predicted to be strong.

17. The apparatus of claim 13, wherein the processor is arranged operably to: receive information indicating that a third SV is invisible currently during the search process; and remove all search task or tasks related to the third SV and rearrange an execution order for remaining search tasks during the search process.

18. The apparatus of claim 13, wherein the processor is arranged operably to: receive information indicating that the maximum current that can be provided to the search engine drops to a predefined level during the search process; and remove one or more search tasks in response to a dropping of the maximum current that can be provided to the search engine during the search process.

19. The apparatus of claim 13, wherein the processor is arranged operably to: receive information indicating that a fourth SV is currently located at an azimuth and elevation angle close to that of a fifth SV and the azimuth and elevation angle is in line of sight with a strong signal, and a tracking process for the fifth SV has completed for a time period shorter than a non-coherent time period in a search task for the fourth SV during the search process; and modify the non-coherent time period in the search task for the fourth SV with the time period in response to received information during the search process.

20. The apparatus of claim 13, comprising:
a controller, coupled to the search engine, comprising a switch coupled between a power source and the correlation circuitry, wherein the correlation circuitry is activated when the switch is turned on,
wherein the processor is arranged operably to: deactivate the correlation circuitry by turning off the switch when the search process has completed or the search process terminates prematurely.
